(19) United States
(12) Patent Application Publication
(10) Pub. No.: US 2021/0075042 A1
(43) Pub. Date: Mar. 11, 2021

(54) REDOX FLOW BATTERY AND METHOD OF OPERATION

(71) Applicant: Fujifilm Manufacturing Europe B.V., Tilburg (NL)

(72) Inventor: Jacko HESSING, Tilburg (NL)

(73) Assignee: Fujifilm Manufacturing Europe B.V., Tilburg (NL)

(21) Appl. No.: 16/772,212

(22) PCT Filed: Dec. 13, 2018
(86) PCT No.: PCT/EP2018/084803

§ 371 Date: Jun. 12, 2020

(30) Foreign Application Priority Data
Dec. 15, 2017 (GB) 1721016.2

(51) Int. Cl. H01M 8/04746; H01M 8/04186; H01M 8/04082; H01M 8/18; H01M 8/04537

(52) U.S. Cl. CPC H01M 8/04753; H01M 8/04186; H01M 8/04634; H01M 8/188; H01M 8/04201

(57) ABSTRACT

A redox flow battery system (10) comprises an electrochemical cell (11) divided into first and second compartments (11a, 11b) by a porous membrane (13). Each of the first and second compartment (11a, 11b) houses an electrode. An electrolyte storage tank (14) has a first volume (14a) and a second volume (14b) separated from the first volume by a movable separator (15). The first volume (14a) of the storage tank (14) is in fluid communication with the first compartment (11a) and the second volume (14b) of the storage tank (14) is in fluid communication with the second compartment (11b). The system (10) also includes a flow control system configured to move fluid between the first volume (14a) of the storage tank and the second volume (14b) of the storage tank through the first and second compartments (11a, 11b) of the electrochemical cell (11). An associated method is also described.

### FIELD OF THE INVENTION

The present invention relates to a redox flow battery system comprising a movable separator between two electrolyte storage volumes. More particularly, the present invention relates to a system and method for moving a fluid comprising species of first and second active redox couples through an electrochemical cell, from one side of the movable separator to the other side of the movable separator.

### BACKGROUND OF THE INVENTION

Redox flow battery systems can provide convenient storage of energy in chemical form due to their flexible construction (physical separation of energy and power components), long life cycle and quick response times. A wide range of chemistries have been employed in redox flow battery systems, leading to different storage tank arrangements.

U.S. Pat. No. 4,786,567A describes an all-vanadium redox battery comprising an electrochemical cell having a first half cell and a second half cell. The system further comprises four electrolyte storage tanks: a catholyte storage reservoir, a catholyte charged reservoir, an anoltye storage reservoir and an anolyte charged storage reservoir. The catholyte storage reservoir and the catholyte charge reservoir are in fluid communication with the first half of the electrochemical cell, whilst the anolyte storage reservoir and the anolyte charge reservoir are in fluid communication with the second half of the electrochemical cell.

PCT Application Publication No. WO2015/187240A1 describes a redox flow battery that comprises two electrolyte storage tanks. A first electrolyte storage tank contains a solution comprising cations of a metal Mⁿ⁺ and a second electrolyte storage tank contains a solution comprising I-based species. The first electrolyte storage tank is in fluid communication with a first half cell of the electrochemical cell, whilst the second electrolyte storage tank is in fluid communication with a second half cell of the electrochemical cell.

One of the limitations of existing redox flow battery systems is the large volume of the storage tanks required to store the electrolyte. Particularly in high energy applications (e.g. renewable energy storage), redox flow batteries comprising multiple large tanks will require a very large footprint.

### SUMMARY OF THE INVENTION

The present invention seeks to provide an improved redox flow battery system that reduces the footprint required for the electrolyte storage tanks and reduces the complexity of fluid flow through the system.

In a first aspect of the invention there is provided a redox flow battery system comprising: an electrochemical cell having a first compartment housing a first electrode and a second compartment comprising a second electrode, the first and second compartments being separated from each other by a porous membrane; an electrolyte storage tank comprising a first volume and a second volume, the first and second volumes being separated from each other by a movable separator; wherein the first volume is in fluid communication with the first compartment and the second volume is in fluid communication with the second compartment, and wherein the system further comprises a flow control system configured to move fluid between the first volume of the storage tank and the second volume of the storage tank through the first and second compartments of the electrochemical cell.

In a second aspect of the invention, there is provided a method for operating a redox flow battery comprising an electrolyte storage tank and an electrochemical cell having a first compartment separated from a second compartment by a porous membrane, the first and second compartments containing first and second electrodes respectively, the method comprising a charge cycle with the steps of: providing, in a first volume of the storage tank, an electrolyte solution comprising a first species of a first active redox couple and, optionally, a first species of a second active redox couple; moving the fluid from the first volume of the storage tank to the first compartment of an electrochemical cell; applying an external voltage across the first and second electrodes; reducing the first species of the first active redox couple at the first electrode to form a second species of the first active redox couple; moving the fluid through a porous membrane into a second compartment of an electrochemical cell comprising the second electrode; oxidising the first species of the second active redox couple at the second electrode to form a second species of the second active redox couple; and moving the fluid from the second compartment of the electrochemical cell to a second volume of the storage tank, wherein the first and second volumes of the storage tank are separated by a movable separator, and wherein the step of moving the fluid through the electrochemical cell involves moving the movable separator. In exemplary embodiments, the rate at which the fluid is pumped through the first electrode, the membrane and then the second electrodes can be adapted to the power which is supplied to or from the battery.

In a third aspect of the invention, there is provided a method of operating a redox flow battery comprising an electrolyte storage tank and an electrochemical cell having a first compartment separated from a second compartment by a porous membrane, the first and second compartments containing first and second electrodes respectively, the method comprising a discharge cycle with the steps of: moving a fluid comprising a solvent from a second volume of a storage tank to a second compartment of an electrochemical cell comprising a second electrode; reducing, at the second electrode, a second species of a second active redox couple to form a first species of the second active redox couple; moving the fluid, optionally comprising the first species of the second active redox couple, from the second compartment of the electrochemical cell through the porous membrane to the first compartment of the electrochemical cell; oxidising, at the first electrode, a second species of a first active redox couple to form a first species of the first active redox couple; moving the fluid, optionally comprising the first species of the second active redox couple and the first species of the first active redox couple, from the first compartment of the electrochemical cell to a first volume of the storage tank, wherein the first and second volumes of the storage tank are separated by a movable separator, and wherein the step of moving the fluid through the electrochemical cell involves moving the movable separator. In exemplary embodiments, the rate at which the fluid is pumped through the first electrode, the membrane and then the second electrode can be adapted to the power which is supplied to the battery. (In a discharge mode, the flow through the system can be adapted on the basis of the power the battery is configured to supply.)

By providing a single, separated tank for storage for all of the electrolyte(s), the present invention can significantly reduce the footprint of redox flow battery system compared to conventional, multi-tank arrangements. Moreover, by providing a movable separator between the first and second volumes of an electrolyte storage tank, the control of fluid flow through the system can by simply an effectively managed and the state of charge of the system can be indicated by the position of the movable separator in the electrolyte storage tank. Yet further advantages are provided by the inventive system which allows the use of a single electrolyte solution (comprising one or more electrolyte pairs in the same solution). By providing one solution that can pass through the electrochemical cell, the lifetime of the redox flow battery system is not reduced by (unintentional) mixing of different electrolyte solutions. Moreover, maintenance and safety procedures can be simplified since the electrolyte solution present in all parts of the system is similar. Other advantages of the present invention will be apparent to the skilled person in light of the following disclosure.

### BRIEF DESCRIPTION OF THE DRAWINGS

The present invention will now be described by reference to the following description of exemplary embodiments and the attached drawings, in which:

FIG. 1 shows redox flow battery arrangement that forms part of the state of the art;

FIGS. 2A and 2B show a redox flow battery arrangement in accordance with a first aspect of the present invention.

FIG. 3 shows a system for controlling a redox flow battery in according with the present invention; and

FIGS. 4A and 4B each show a schematic of the steps of a method of operating a flow battery according to the present invention.

### DETAILED DESCRIPTION OF EXEMPLARY EMBODIMENTS

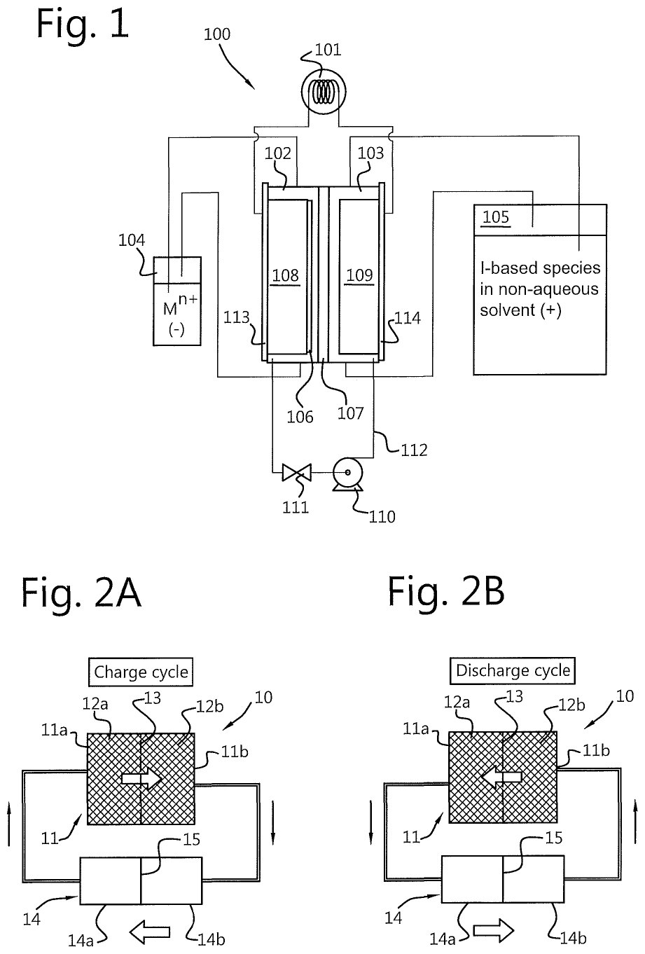

FIG. 1 shows a redox flow battery system of the type known in the art from WO2015/187240A1, which is incorporated by reference in its entirety. The system 100 comprises an electrochemical cell comprising a first compartment or “half-cell” 102 and a second compartment or “half-cell” 103. The first compartment 102 comprises a first electrode 108 and the second compartment 103 comprises a second electrode 109. The first and second compartments 102, 103 are separated from each other by a porous membrane 107. The first electrode 108 and the second electrode 109 are connected to a load or voltage source 101.

The first compartment 102 is in fluid communication with a first electrolyte storage tank 104. The second compartment 103 is in fluid communication with a second electrolyte storage tank 105. A pump 110 is provided to move fluid between the two storage tanks and their respective compartments of the electrochemical cell.

The flow battery shown in FIG. 1 is configured as a metal-iodide flow battery. The first electrolyte storage tank 102 contains cations Mⁿ⁺ (e.g. Zn²⁺) of a metal M in solution. The second electrolyte storage tank 103 contains a solution comprising at least one I-based species (e.g. I⁻, I⁻₃). In practice, both tanks can comprise zinc iodide solution (Znl₂).

To charge the battery 100, an external voltage is applied across the first and second electrodes 108, 109. In the first half 102 of the electrochemical cell, at the first (negative) electrode 108, Mⁿ⁺ cations are reduced to form M⁰. In the second half 103 of the electrochemical cell, at the (positive electrode) 109, a first I-base species (e.g. I⁻ anions) are oxidised to form another I-based species (e.g. I₃⁻ or I₂). A charge carrier (not shown) moves through the porous membrane 107 to maintain charge balance in the first and second compartments 102, 103 of the electrochemical cell. The energy supplied to charge the battery is thus stored as chemical energy in the liquid. Once the state of charge of the liquid in the electrochemical cell reaches a maximum (e.g. a predetermined proportion or all Mⁿ⁺ cations have been reduced and/or all or a predetermined proportion I⁻ anions have been oxidised), the fluid in the electrochemical cell can be replenished with fluid from the storage tanks 104 and 105.

During a discharge cycle of the battery 100, the process is reversed to supply a voltage across the first and second electrodes 108, 109 to an external load 101. During a discharge cycle, an I-based species is reduced at the second electrode 109, which this time acts as a negative electrode, in the second half of the electrochemical cell (the second compartment 103). At the first electrode 108, which this time acts as a positive electrode, the M⁰ is oxidised to form Mⁿ⁺. A charge carrier (not shown) moves through the porous membrane 107 to maintain charge balance in the first and second compartments 102, 103 of the electrochemical cell. A current is thus provided by the electrochemical cell 100 to the associated load 101.

One of the problems with the arrangement shown in FIG. 1 is the large footprint of the electrolyte tanks required by the system 100. The present invention can reduce the footprint of a redox flow battery system by combining the first and second electrolyte storage tanks into a single storage tank divided into first an second volumes by a movable separator.

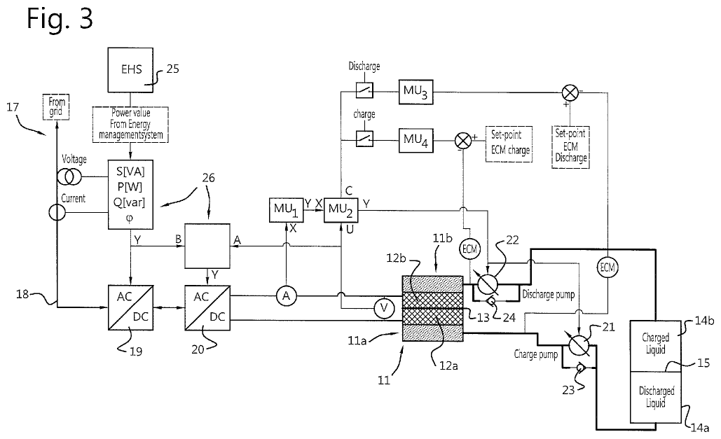

FIGS. 2A and 2B shows a redox flow battery system according to a first embodiment of the present invention. As shown in FIGS. 2A and 2B, the redox flow battery system 10 comprises an electrochemical cell having a first compartment 11a and a second compartment 11b. The first compartment 11a comprises a first electrode 12a and the second compartment 11b comprises a second electrode 12b. As shown in FIGS. 2A and 2B, the first and second compartments 11a, 11b are separated from each other by a porous membrane 13. In a similar manner to that described above with reference to FIG. 1, the first and second electrodes 12a, 12b are configured to be connected to an external power supply (for charging) and/or to an external load (for discharging).

An electrolyte storage tank 14 comprises a first volume 14a and a second volume separated from each other by a movable separator 15. The movable separator 15 is configured to separate the electrolyte storage tank into two separate compartments 14a, 14b that are not in fluid communication with each other. The movable separator 15 can take the form of a piston, movable foil or other separator that serves to separate one volume of the storage tank from the other such that fluid cannot flow between the first volume 14a of the storage tank 14 and the second volume 14b past the separator. However, as will become apparent with the following description, it is not necessary for the movable separator to provide a perfectly fluid tight seal between the first and second compartments.

The first volume 14a of the electrolyte storage tank 14 is in fluid communication with the first compartment 11a of the electrochemical cell 11 and the second volume 14b of the electrolyte storage tank 14 is in fluid communication with the second compartment 11b of the electrochemical cell 11. In other words, the first volume 14a of the electrolyte storage tank 14 is connected to the first compartment 11a of the electrochemical cell 11 such that fluid can be moved from the first volume 14a of the storage tank 14 to the first compartment 11a of the cell 11 and vice versa. The second compartment 11 of the electrochemical cell 11 is similarly connected to the second volume 14b of the storage tank 14 such that fluid can be moved from the second compartment 11b of the electrochemical cell 11 to the second volume 14b of the storage tank 14. Since the separator between the first and second compartments 11a, 11b is porous, this arrangement provides a loop through which fluid can flow, from the first volume 14a of the storage tank 14 to the second volume 14b of the storage tank 14 via the electrochemical cell 11 (and vice versa). To control the movement of fluid through the electrochemical cell 11, the redox flow battery system 10 further comprises a flow control system configured to move fluid between the first volume 14a of the storage tank 14 and the second volume 14b of the storage tank 14 through the first and second compartments 11a, 11b of the electrochemical cell 11.

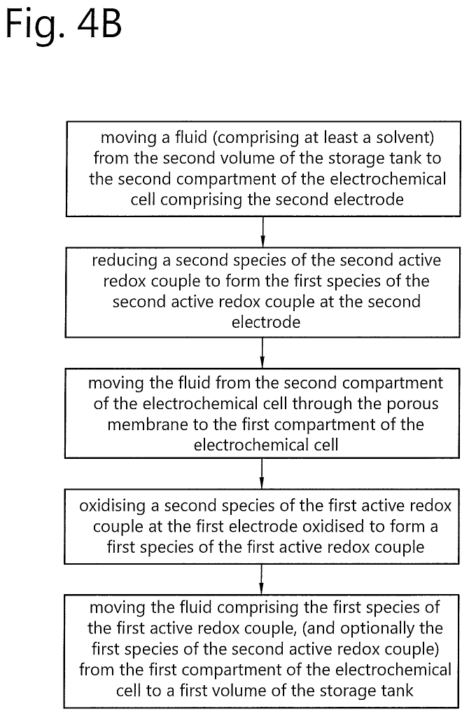

During use, the redox flow battery system 10 described above can be used to move fluid back and forth between the first and second volumes 14a, 14b of the electrolyte storage tank 14, storing or discharging chemical energy via redox reactions occurring at the first and second electrodes 12a, 12b. Use of the system will be described in more detail below, with reference to FIGS. 4A-B and Examples 1 to 4.

Referring again to FIGS. 2A and 2B, the flow control system can be configured to vary the rate of flow of fluid through the electrochemical cell based on the energy requirements (charge or discharge) of the system. In other words, the rate at which the fluid is pumped through the first electrode, the membrane and then the second electrodes (through the electrochemical) can be adapted to the power which is supplied to or from the battery by the flow control system.

By controlling the flow of fluid through the electrochemical cell, the energy supplied to and from the battery can be controlled. In contrast to a conventional redox flow battery (in which the rate of charging is limited by diffusion of charge carriers across the porous membrane), the present invention allows control of the flow of redox species across the porous membrane. Thus, in the inventive method, the rate at which the fluid is pumped through the first electrode 12b, the membrane 13 and then the second electrodes 12b (through the electrochemical cell 11) can be adapted to the energy to be supplied to or from the battery by the flow control system.

In at least some embodiments, the flow control system can comprise a drive system for moving the movable separator 15 within the storage tank 14. Moving the movable separator 15 within the storage tank 14 decreases the first volume 14a and increases the second volume 14b, and vice versa. It will be appreciated that when the first volume decreases, fluid is forced from the first volume, through the first and second compartments 11a, 11b of the electrochemical cell 11 and into the second (now larger) volume 14b of the storage tank 14 (see FIG. 2A). Similarly, if the movable separator 15 is moved to decrease the second volume 14b of the storage tank 14, fluid is forced in the opposite direction through the electrochemical cell 11 and into the first volume 14a of the storage tank 14 (see FIG. 2B). By driving the movement of the fluid through the redox battery flow system 10 with the movable separator 15, a simple and effective method of moving fluid between the first and second volumes 14a, 14b of the storage tank 14 can be provided with a single drive source. However, the skilled person will appreciate that other flow control configurations are possible. For example, the redox flow battery system 10 can be provided with one or more separate pumps for moving fluid between the first and second volumes of the storage tank 14.

The maximum charge/discharge current of a redox flow battery is limited by the rate of redox reactions occurring at the positive and negative electrodes. Factors that affect the rate of the redox reaction include: mass transfer variables (such as rate of diffusion, convection flow, etc.), electrical variables (such as potential, current, charge), electrode variables (such as material, surface area, surface condition), solution variables (such as concentration of active redox species, solvent, purity) and external variables (such as temperature).

Redox flow battery systems according to the present invention can control one or more of these variables to optimise the system for the required application (e.g. the discharge current can be chosen according to application requirements).

One of the factors that the redox battery flow system 10 can control to optimise battery performance is the rate of flow of fluid through the electrochemical cell. This can be achieved with the flow control system, which can be further configured to automatically control and adjust the flow of fluid through the electrochemical cell based on measured variables, detected within the battery system or external thereto (e.g. at the load or within the power network configured to drive the charging cycle).

The flow of fluid (and thus the flow of electrolytes) through the electrochemical cell 11 can be managed based on the requirements of the power network 17 (e.g. reactive power compensation requirements). For example, the flow control system can comprise at least one measurement unit configured to measure the current and/or voltage and/or conductivity across the electrochemical cell 11. The voltage measurement and the current measurement can be combined to control a requested energy flow through the electrochemical cell.

In at least some embodiments, the flow control system can comprise a measurement unit configured to measure the conductivity of the fluid in the electrochemical cell. To get the optimum control of fluid flow through the cell, the conductivity of outgoing liquid from the stack can be measured. Since conductivity of outgoing fluid can be related to the concentration of electrolyte in the solution, the measured conductivity is related to the state of charge of the fluid leaving the electrochemical cell. Based on this information, the flow rate of fluid through the cell can be increased or decreased (e.g. to ensure that the state of charge of fluid leaving the electrochemical cell during a charge cycle is optimised). Thus, the flow control system can be configured to control the rate of flow of fluid through the electrochemical cell based on the measured conductivity of the fluid in the electrochemical cell.

The skilled person will appreciate that an optimised state of charge can be a maximum state of charge or an intermediate state of charge, depending on the electrode configuration and the electrolyte solution(s) used to supply active redox couples to the first and second half of the electrochemical cell. Further details regarding possible active redox couple combinations will be provided below.

Alternatively or additionally, the flow control system can be configured to vary the rate of flow of fluid through the electrochemical cell based on a charge current set-point or a discharge current set-point provided by an energy management system. For example, an energy management system may dictate a set-point for current supplied to or from the electrochemical cell 11 (depending on whether the battery is operating in a charge or discharge mode). During a charge cycle, the energy management system can measure a current to be supplied to the redox flow battery system 10 from an external source and can optimise the rate of flow of fluid through the electrochemical cell 11 accordingly. Similarly, the energy management system can control the flow of fluid through the cell during a discharge cycle depending on the relevant operating requirements of the load.

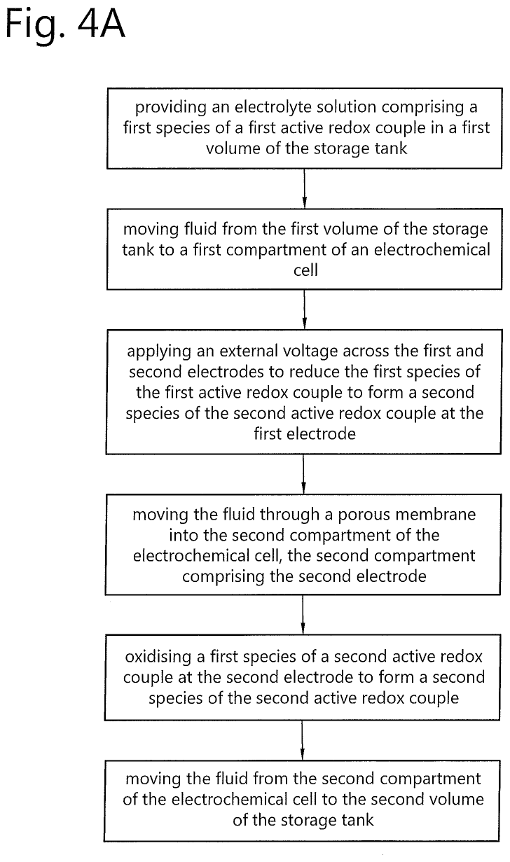

One possible implementation of a flow control system for use with the present invention will now be described with reference to FIG. 3. As shown in FIG. 3, the control system can comprise a redox flow battery system 10, as described with reference to FIGS. 2A and 2B, comprising an electrolyte storage tank 14 and an electrochemical cell (or “stack”) 11.

In the embodiment shown in FIG. 3, the redox flow battery system 10 is employed in a system for reactive power compensation of a power network with a variable or sub-optimal power factor. The redox flow battery system 10 is operably coupled to a grid or power network 17 at a grid connection point 18. An AC/DC converter 19 and a DC/DC converter 20 are operatively connected between the grid connection point 18 and the first and second electrodes 12a, 12b of the electrochemical cell 11. The AC/DC converter 19 can be, for example, a PWM (pulse width modulated) converter configured to compensate for reactive power in the power network 17. The output of the AC/DC converter 19 is supplied to the DC/DC converter 20, which is configured to supply an optimised DC current to the first and second electrodes 12a, 12b of the electrochemical cell 11 to charge the electrolytes in the first and second compartments 11a, 11b of the electrochemical cell 11. During a discharge cycle, the system operates in reverse: as the redox flow battery system 10 discharges, current is provided from the electrochemical cell 11 to the DC/DC converter 20. The DC/DC converter optimises the current to be supplied to the AC/DC converter, which in turn supplies AC current to the power network 17 (as active or reactive power). Of course, the skilled person will appreciate that in some embodiments, the DC/DC converter 20 can be omitted and the input/output of the AC/DC converter 19 can be supplied directly from/to the first and second electrodes 12a, 12b.

The control system further comprises a first measurement unit MU₁ configured to measure a current input/output from the DC/DC converter 20 (or the AC/DC converter 19 when the DC/DC converter is omitted). A second measurement unit MU₂ is configured to measure a voltage across the first and second electrodes 12a, 12b of the electrochemical cell 11. A controller(s) 26 (e.g. a regular PID controller) is associated (or integrated with) the first measurement unit MU₁ and the second measurement unit MU₂ and is configured to measure and control the requested energy flow through the electrochemical cell 11 based on the voltage and current measurements from the first and second measurement units MU₁, MU₂. The required energy flow is dictated by an energy management system 25, which determines the required energy flow to and from the redox flow battery system 10. Based on the measured energy flow to/from the electrochemical cell 11 (product of measured voltage and current measured by the first and second measurement units MU₁, MU₂) and/or the required energy flow requested by the energy management system 25, the controller adjusts the AC/DC converter 19 and the DC/DC converter 20.

The DC/DC converter 20 output value is related to the voltage between the first and second electrodes 12a, 12b of the electrochemical cell 11. Due to the progress of the redox reactions at the electrodes 12a, 12b and deposition of species in the electrochemical cell, the voltage across the first and second electrodes 12a, 12b will vary due to the state of charge of the electrolytes in the electrochemical cell.

The energy that is charged or discharged by the electrochemical cell 11 is a product of the voltage and current measured by the first and second measurement units MU₁, MU₂. The (measured) energy value will thus be calculated by the controller(s) associated or integrated with the first and second measurement units MU₁, MU₂. The output of this controller is a signal that represents the power per volume of the fluid moving through the redox flow battery system 10. Based on this power per volume value, the flow of fluid through the cell 11 can be controlled.

To optimise the energy flow through the electrochemical cell, the flow of fluid (and thus redox species) through the electrochemical cell 11 can be varied using a flow control system. In at least one embodiment, the control system can comprise third and fourth measurement units MU₃, MU4 configured to measure the conductivity of fluid exiting the electrochemical cell 11. Since the conductivity of the fluid leaving the electrochemical cell 11 is related to the electrolyte concentration in the fluid, optimum liquid conductivity can be determined and can be used as a feedback signal to the power per volume controller. The skilled person will appreciate that the first measurement unit, the second measurement unit, third measurement unit and the controller may be combined in a single control unit (not shown) or provided in separate dedicated control units.

Advantageously, the present invention allows for the state of charge of the redox flow battery system 10 to be determined by the liquid levels in the first and second volumes 14a, 14b of the electrolyte storage tank (e.g. by determining the position of the movable separator 15).

The fluid can be moved around the system in different ways. As shown in FIG. 3, the system can comprise first and second pumps 21, 22 configured to move the electrolyte fluid through the redox flow battery system 10. For example, the first pump 21 can be configured to pump fluid from the first volume 14a of the storage tank 14 to the second volume 14b of the storage tank 14 (via the electrochemical cell 11) during a charging cycle. The second pump 22 can be configured to pump fluid from the second volume 14b of the storage tank 14 to the first volume 14a of the storage tank 14 (via the electrochemical cell 11) during a discharge cycle. The energy management system 25 can select which of the first and second pups 21, 22 to activate based on whether the system is in a charge cycle of a discharge cycle. The pumps 21, 22 are controlled based on feedback from the flow control system described above to vary the volume of fluid passing through the electrochemical cell per unit time.

To prevent fluid flow from the second volume 14b of the tank 14 to the first volume 14a of the tank 14 during a charge cycle (and vice versa for a discharge cycle), first and second one-way valves 23, 24 can be associated with the first and second pumps 21, 22.

As an alternative to first and second pumps 21, 22, the flow of fluid through the electrochemical cell 11 can be controlled by actively moving the movable separator 15. This is an advantageously simple method of flow control that is facilitated by the inventive tank architecture of the present invention.

Referring again to FIGS. 2A and 2B, the electrodes 12a, 12b can be configured as flow-past electrodes or flow-through electrodes. Flow past electrodes can be arranged within the first and second compartments of the electrochemical cell 11 such that fluid containing electrolytes flows past the surface of the electrodes 12a, 12b, where redox reactions can take place. In some embodiments, flow-through electrodes can be used, in which the fluid from the first volume 14a of the electrolyte storage tank 14 flows through the first and second electrodes 12a, 12b before reaching the second volume 14b of the storage tank 14. In these embodiments, the electrodes 12a, 12b can be configured as porous electrodes (e.g. a conductive felt or matrix of conductive material through which the fluid from the electrolyte storage tank can flow).

The porous separating membrane 13 can be ion selective. For example, the porous separating membrane 13 can be a porous selective exchange membrane for allowing passage of anions therethrough, whilst limiting or eliminating passage of cations. In other embodiments, the porous membrane 13 can be non-selective, allowing passage of all ions in solution therethrough. Suitable porous membranes (or porous separators) are described in WO2015/187240A1, which is incorporated by reference in its entirety.

The electrochemical cell 11 can be formed with various constructions that will be apparent to the person skilled in the art. For example, the cell 11 can be formed with a first protective foil and a second protective foil for protecting the first and second electrodes. In this construction, the first and second electrodes 12a, 12b and the ion selective membrane 13 are disposed between the first and second protective foils. In some embodiments, the electrochemical cell 11 can further comprise a first inflow spacer disposed between the first protective foil and the first electrode and a second outflow spacer between the second electrode and the second protective foil. This provides space for the inflow of fluid from the electrolyte storage tank 14 to the first and second compartments 11a, 11b of the electrochemical cell 11. The spacer further ensures a large electrode surface area across which the redox fluid can spread across the electrodes to ensure that the flow of fluid through the electrodes is more evenly distributed throughout the volume of the electrode. This can be particularly advantageous because it ensures a large electrode surface area available for electron transfer and it further ensures that deposition of the second species of the first active redox couple (e.g. Zn⁰—see Examples 1 and 2) occurs evenly throughout the electrode.

The first volume 14a of the electrolyte storage tank 14 can comprise a liquid containing a first species of a first active redox couple and a first species of a second active redox couple. This means that the fluid in the first volume 14a of the storage tank 14 can contain the chemical species for redox reactions in the first compartment 11a of the electrochemical cell 11 (the first half cell) and the second compartment 11b of the electrochemical cell 11 (the second half cell)—see Example 1.

In alternative embodiments, the first volume 14a of the electrochemical cell can comprise only a first species of a first active redox couple. In these embodiments, the first species of the second active redox couple is provided as a component of the second compartment 11b of the electrochemical cell 11 (e.g. as part of the second electrode 12b)—see Example 4.

The second volume 14b of the electrolyte storage tank 14 can comprise a liquid containing the first species of the first active redox couple and a second species of the second active redox couple in solution. This means that (partly) the first species of the first active redox couple must be able to pass from the first compartment 11a of the electrochemical cell 11, through the porous membrane 13 into the second compartment 11b of the electrochemical cell 11 and into the second volume 14b of the storage tank 14—see Example 1. However, in an alternative embodiment, the liquid in the second volume 14b of the storage tank 14 can be substantially devoid of the active redox species. For example, the fluid in the second volume 14b of the storage tank 14 can be a solvent without species of the first and second redox couples—see Example 2.

In some embodiments, the first species of the first active redox couple is a metal species and the first species of the second active redox couple is an I-based species selected from the group consisting of: I⁻ anions, I₂ and anions of Ix (where x is a number greater than or equal to 3). More particularly, first active redox couple comprises zinc and cations of zinc (e.g. Zn²⁺) and the second active redox couple comprises two different I-based species (e.g. I₂ and I⁻)—see Examples 1 and 2. However, the skilled person will appreciate that other metals may be used, e.g. as described in WO2015/187240A1.

The redox flow battery system 10 is charged and discharged as follows:

Referring now to FIG. 4A, a charging cycle of the redox flow battery system 10 comprises the steps of: providing, in a first volume 14a of the storage tank 14, an electrolyte solution comprising a first species of a first active redox couple. The fluid from the first volume 14a of the storage tank 14 is moved to the first compartment 11a of the electrochemical cell 11. An external voltage is applied across the first and second electrodes 12a, 12b such that the first electrode 12a is configured as a negative electrode and the second electrode 12b is configured as a positive electrode. The charging cycle further comprises the steps of reducing the first species of the first active redox couple at the first electrode 12a to form a second species of the first active redox couple, moving the fluid through a porous membrane 13 into the second compartment 11b of the electrochemical cell 11 comprising the second electrode and oxidising a first species of the second active redox couple at the second electrode to form a second species of the second active redox couple. The fluid from the second compartment 11b of the electrochemical cell 11 is then moved to the second volume 14b of the storage tank 14.

As described above, the first and second volumes 14a, 14b of the storage tank 14 are separated by a movable separator 15. Accordingly, the step of moving the fluid through the electrochemical cell 11 involves moving the movable separator 15.

In the method described above, the second species of the first active redox couple remains in the first compartment 11a of the electrochemical cell 11 (i.e. does not pass through the porous membrane 13). In practice this can occur because the second species of the first active redox couple is deposited in the first electrode (e.g. as a solid, e.g. a metallic solid).

The step of moving the fluid through the electrochemical cell comprises controlling the flow rate at which fluid is pumped from the first compartment 11a, through the porous membrane 13 and into the second compartment 11b. By controlling the flow of fluid through the electrochemical cell, the energy supplied to and from the battery can be controlled. In contrast to a conventional redox flow battery (in which the rate of charging is limited by diffusion of charge carriers across the porous membrane), the present invention allows control of the flow across the porous membrane. Thus, in the inventive method, the rate at which the fluid is pumped through the first electrode 12b, the membrane 13 and then the second electrodes 12b (through the electrochemical cell 11) can be adapted to the energy to be supplied to or from the battery by the flow control system.

In some embodiments, the first species of the second active redox couple is present in the electrolyte solution provided in the first volume 14a of the storage tank 14 such that it travels through the porous membrane 13 before being oxidised in the second compartment 11b of the electrochemical cell 11 (see Example 1). In some embodiments, the first species of the first active redox couple and the first species of the second active redox couple are dissociated ions of an electrolyte pair (see Examples 1 and 2). However, in other examples, the first species of the first and second active redox couples respectively may be dissolved in a common solvent without forming an electrolyte pair (see Example 3). In yet further embodiments, the first species of the second active redox couple may be provided in the second compartment e.g. as a metallic electrode (see Example 4).

In some embodiments of the invention, the first and second species of the first active redox couple are metal species having different oxidation states and the first and second species of the second active redox couple are different I-based species selected from the group consisting of: I⁻ anions, I₂ and anions of Ix (where x is a number greater than or equal to 3). In one exemplary implementation, fluid provided in the first volume 14a of the electrolyte storage tank 14 is ZnI₂ in aqueous solution. In this embodiments, the first species of the first active redox couple is Zn²⁺ and the second species of the first active redox couple is Zn⁰ (Zn²⁺ is reduced during a charging cycle at the first, negative electrode 12a to form Zn⁰, thereby providing the first active redox couple). The first species of the second active redox couple is I⁻ and the second species of the second active redox couple is another I-based species, e.g. I₃⁻ or I₂ or a combination thereof (I⁻ is oxidised at the second, positive electrode to form I₃⁻ or I₂—thereby providing the second active redox couple). Management of the extent of oxidation in the second compartment of the electrochemical cell can be controlled by the control system, which can limit the operating voltages or charge/discharge capacity, e.g. so that I− is oxidised to Iₓ⁻ (where x is an integer greater than or equal to 3). In such embodiments, the redox potential is correspondingly lower.

Where the second species of the second active redox couple is I₂, the step of forming the second species of the second active redox couple comprises depositing I₂ in the second compartment 11b of the electrochemical cell 11 such that the fluid moved to the second volume 14b of the electrolyte storage tank 14a solvent substantially devoid of the active redox species, e.g. water.

In embodiments where the second species of the second active redox couple is I₃_{^{−}}, the fluid moved from the second compartment 11b of the electrochemical cell 11 to the second volume 14b of the electrolyte storage tank 14b is ZnI₆ in aqueous solution. In this embodiment, the porous separator 13 should be configured to allow passage of Zn²⁺ cations through the membrane 13.

In addition to the charge cycle describe above, or as an independent cycle, methods according to the present invention include a discharge cycle for a redox flow battery system.

FIG. 4B shows, in schematic form, a discharge cycle of the redox flow battery system 10. The discharging cycle shown in FIG. 4B is in essence the reverse of the charging cycle described with reference to FIG. 4A. As shown in FIG. 4B, the discharge cycle comprises the steps of: moving a fluid (comprising at least a solvent) from the second volume 14b of the storage tank 14 to the second compartment 11b of the electrochemical cell 11 comprising the second electrode 12b; reducing, at the second electrode 12b, the second species of the second active redox couple to form the first species of the second active redox couple; moving the fluid from the second compartment of the electrochemical cell through the porous membrane to the first compartment of the electrochemical cell. At the first electrode 12a, the second species of the first active redox couple is oxidised to form a first species of the first active redox couple. The fluid comprising the first species of the first active redox couple is then moved from the first compartment 11a of the electrochemical cell 11 to a first volume 14a of the storage tank 14. Again, because the first and second first and second volumes 14a, 14b of the storage tank 14 are separated by a movable separator 15, the step of moving the fluid through the electrochemical cell 11 involves moving the movable separator 15.

In some embodiments, the first species of the second active redox couple is moved through the porous membrane such that it is present in the electrolyte solution delivered to the first volume 14a of the storage tank 14 (see Example 1). In some embodiments, the first species of the first active redox couple and the first species of the second active redox couple are an electrolyte pair (see Examples 1 and 2). However, in other examples, the first species of the first and second active redox couples respectively may be dissolved in a common solvent without forming an electrolyte pair (see Example 3). In yet further embodiments, the first species of the second active redox couple may be provided in the second compartment e.g. as a metallic electrode (see Example 4) such that it is not present in the electrolyte solution contained in the first volume 14a of the storage tank 14.

In embodiment having porous electrodes (as discussed above with reference to FIGS. 2A and 2B, the step of moving fluid between the first and second volumes of the electrolyte storage tank involves moving the fluid through the first and second porous electrodes. The discharge cycle described with reference to FIG. 4B can also employ the same zinc iodide electrolyte described above to provide first and second active redox couples: wherein the first and second species of the first active redox couple are metal species having different oxidation states and the first and second species of the second active redox couple are different I-based species selected from the group consisting of: I⁻ anions, I₂ and anions of Ix (where x is a number greater than or equal to 3). Again, the first species of the first active redox couple is Zn²⁺ and the second species of the first active redox couple is Zn⁰ (Zn⁰ is oxidised during a discharging cycle at the first, positive electrode 12a to form Zn²⁺, thereby providing the first active redox couple). The first species of the second active redox couple is I⁻ and the second species of the second active redox couple is another I-based species, e.g. I₃⁻ or I₂ or a combination thereof. (I₂ or I₃⁻ is reduced at the second, negative electrode to form I⁻, thereby providing the second active redox couple).

During discharge cycles, the fluid in the second volume 14b of the electrolyte storage tank 14 can be ZnI₆ or solvent substantially devoid of active redox species. In the first case, the species reduced at the second (negative) electrode is I₃⁻ (or a combination of I₃⁻ and I₂). In the second case, the species reduced at the second (negative) electrode is I₂.

In both charging and discharging cycles, as described above, the movement of fluid between the first and second volumes 14a, 14b of the storage tank 14 via the first and second compartments 11a, 11b of the electrochemical cell 11 is controlled by controlling movement of the movable separator 15 within the storage tank 14 with a drive system. The method can further comprise measuring the conductivity of fluid in the electrochemical cell. In some embodiments, the method includes the step of controlling the rate of flow of fluid through the electrochemical cell based on the measured conductivity of fluid in the electrochemical cell. Independently or in combination with this measured information, the flow control system varies the rate of flow of fluid through the electrochemical cell based on a set-point provided by an energy management system.

The skilled person will appreciate that the redox flow battery system according to the present invention can be used with many different active redox couples. The following non-limiting examples can be employed in combination with the system and methods described herein:

### EXAMPLE 1

| Charge cycle | | Discharge cycle | |
|---|---|---|---|
| First volume of | 3ZnI₂ | Second volume of | ZnI₆ |
| storage tank | | storage tank | |
| At first electrode | 3Zn²⁺ + 4e⁻ → 2Zn⁰ + Zn²⁺ | At second | 2I₂ + 2I⁻ + 4e⁻ → 6I⁻ |
| | | electrode | |
| Moves across | Zn²⁺ + 6I⁻ | Moves across | Zn²⁺ + 6I⁻ |
| membrane | | membrane | |
| At second | 6I⁻ − 4e⁻ → 2I₂ + 2I⁻ | At first electrode | 2Zn⁰ + Zn²⁺ − 4e⁻ → 3Zn²⁺ |
| electrode | | | |
| Second volume of | ZnI₆ | First volume of | 3ZnI₂ |
| storage tank | | storage tank | |

Electrodes: Porous carbon electrodes e.g. carbon felts
Voltage: Charging >1.3 V; discharge at 1.3 V
Solvent: Water, e.g. containing additives for preventing dendrite formation of the Zn⁰
Membrane: Porous non-charged membrane (configured to allow passage of I− and Zn²⁺ through the membrane)

### EXAMPLE 2

| Charge cycle | | Discharge cycle | |
|---|---|---|---|
| First volume of | ZnI₂ | Second volume of | H₂O |
| storage tank | | storage tank | |
| At first electrode | Zn²⁺ + 2e⁻ → | At second | I² + 2e⁻ → 2I⁻ |
| | Zn⁰ | electrode | |
| Moves across | 2I⁻ | Moves across | 2I⁻ |
| membrane | | membrane | |
| At second | 2I⁻ − 2e⁻ → I² | At first electrode | Zn⁰ − 2e⁻ → Zn²⁺ |
| electrode | | | |
| Second volume of | H₂O | First volume of | 2ZnI₂ |
| storage tank | | storage tank | |

Electrodes: Porous carbon electrodes e.g. carbon felts
Voltage: Charge >1.3 V; discharge at 1.3 V
Solvent: Water, e.g. containing additives for preventing dendrite formation of the Zn⁰
Membrane: Porous membrane, preferably a positively charged porous membrane (configured to allow passage of I− but substantially prevent or limit passage of Zn²⁺ therethrough)

### EXAMPLE 3

| Charge cycle | | Discharge cycle | |
|---|---|---|---|
| First volume of | ZnCl₂ + 2FeCl₂ | Second volume of | 2FeCl₃ |
| storage tank | | storage tank | |
| At first electrode | Zn²⁺ + 2e⁻ → | At second | 2Fe³⁺ + 2e⁻ → |
| | Zn⁰ | electrode | 2Fe²⁺ |
| Moves across | 6Cl⁻ + 2Fe²⁺ | Moves across | 6Cl⁻ + 2Fe²⁺ |
| membrane | | membrane | |
| At second | 2Fe²⁺ − 2e⁻ → | At first electrode | Zn0 − 2e⁻ → |
| electrode | 2Fe³⁺ | | Zn²⁺ |
| Second volume of | 2FeCl₃ | First volume of | ZnCl₂ + 2FeCl₂ |
| storage tank | | storage tank | |

Electrodes: Porous carbon electrodes e.g. carbon felts
Voltage: Charge >1.53 V; discharge at 1.53 V
Solvent: Water, e.g. slightly acidic (e.g. HCl) and preferably containing additives for preventing dendrite formation of the Zn⁰
Membrane: Porous non-charged membrane (configured to allow Fe²⁺ also Cl− to pass therethrough)

### EXAMPLE 4

| Charge cycle | | Discharge cycle | |
|---|---|---|---|
| First volume of | ZnCl₂ | Second volume of | CuCl₂ |
| storage tank | | storage tank | |
| At first electrode | Zn²⁺ + 2e⁻ → | At second (Cu) | Cu²⁺ + 2e⁻ → |
| | Zn⁰ | electrode | Cu⁰ |
| Moves across | 2Cl⁻ | Moves across | 2Cl⁻ |
| membrane | | membrane | |
| At second (Cu) | Cu⁰ − 2e⁻ → | At first electrode | Zn⁰ − 2e⁻ → Zn²⁺ |
| electrode | Cu²⁺ | | |
| Second volume of | CuCl₂ | First volume of | ZnCl₂ + 2FeCl₂ |
| storage tank | | storage tank | |

Electrodes: Porous carbon electrodes e.g. carbon felts
Voltage: Charge >1.1 V; discharge at 1.1 V
Solvent: Water, e.g. containing additives for preventing dendrite formation of the Zn⁰/Cu⁰
Membrane: Porous positively charged membrane (configured to limit or substantially prevent passage of Zn²⁺ and Cu²⁺ therethrough)

The present invention has been described above with reference to a number of exemplary embodiments shown in the drawings. The skilled person will appreciate that modifications and alternative implementations of some parts or elements are possible, and are included in the scope of protection as defined in the appended claims. Such modifications and the associated advantages will be apparent to the person skilled in the art.

1. A redox flow battery system comprising:
an electrochemical cell having a first compartment housing a first electrode and a second compartment comprising a second electrode, the first and second compartments being separated from each other by a porous membrane;
an electrolyte storage tank comprising a first volume and a second volume, the first and second volumes being separated from each other by a movable separator;
wherein the first volume is in fluid communication with the first compartment and the second volume is in fluid communication with the second compartment, and wherein the redox flow battery system further comprises a flow control system configured to move fluid between the first volume of the storage tank and the second volume of the storage tank through the first and second compartments of the electrochemical cell.

2. The system according to claim 1, wherein the flow control system comprises a drive system for moving the movable separator within the storage tank and/or a measurement unit configured to measure the conductivity of the fluid in the electrochemical cell.

3. (canceled)

4. The system according to claim 2, wherein the flow control system is configured to control the rate of flow of fluid through the electrochemical cell based on the measured conductivity of the fluid exiting the electrochemical cell.

5. The system according to claim 1, wherein the flow control system is configured to vary the rate of flow of fluid through the electrochemical cell based on a charge current set-point or a discharge current set-point provided by an energy management system.

6. The system according to claim 1, wherein the first and second electrodes are porous and/or the porous separating membrane is ion selective.

7. (canceled)

8. The system according to claim 1, wherein the electrochemical cell further comprises a first protective foil and a second protective foil, wherein the first and second electrodes and the ion selective membrane are disposed between the first and second protective foils.

9. The system according to claim 8, wherein the electrochemical cell further comprises a first inflow spacer disposed between the first protective foil and the first electrode and a second outflow spacer between the second electrode and the second protective foil.

10. The system according to claim 1, wherein the first volume of the electrolyte storage tank comprises a first species of a first active redox couple and, optionally, a first species of a second active redox couple in solution.

11. (canceled)

12. The system according to claim 10, wherein the second volume of the electrolyte storage tank comprises solvent substantially devoid of electrolytes.

13. The system according to claim 10, wherein:
the first species of the first active redox couple is a metal species;
the first species of the second active redox couple is an I-based species selected from the group consisting of: I⁻ anions, I₂ and anions of Ix (where x is a number greater than or equal to 3).

14. The system according to claim 13, wherein the metal is zinc.

15. A method for operating a redox flow battery system comprising an electrolyte storage tank and an electrochemical cell having a first compartment separated from a second compartment by a porous membrane, the first and second compartments containing first and second electrodes respectively, the method comprising a charge cycle with the steps of:
providing, in a first volume of the storage tank, an electrolyte solution comprising a first species of a first active redox couple;
moving the fluid from the first volume of the storage tank to the first compartment of an electrochemical cell;
applying an external voltage across the first and second electrodes;
reducing the first species of the first active redox couple at the first electrode to form a second species of the first active redox couple;
moving the fluid through a porous membrane into a second compartment of an electrochemical cell comprising the second electrode;
oxidising a first species of a second active redox couple at the second electrode to form a second species of the second active redox couple; and
moving the fluid from the second compartment of the electrochemical cell to a second volume of the storage tank,
wherein the first and second volumes of the storage tank are separated by a movable separator, and wherein the step of moving the fluid through the electrochemical cell involves moving the movable separator.

16. The method according to claim 15, wherein the first species of the second active redox couple is present in the electrolyte solution in the first volume of the storage tank and the second volume of the storage tank.

17. The method according to claim 15, wherein:
the first and second species of the first active redox couple are metal species having different oxidation states;
the first and second species of the second active redox couple are different I-based species selected from the group consisting of: I⁻ anions, I₂ and anions of Ix (where x is a number greater than or equal to 3).

18. The method according to claim 17, wherein:
the first species of the first active redox couple is Zn²⁺;
the first species of the second active redox couple is I⁻;
the second species of the first active redox couple is Zn⁰; and
the second species of the second active redox couple is I₃⁻ or I₂.

19. The method according to claim 18, wherein the second species of the second active redox couple is I₂, and wherein the step of forming the second species of the second active redox couples comprises depositing I₂ in the second compartment of the electrochemical cell such that the fluid moved to the second volume of the electrolyte storage tank is a solvent substantially devoid of the active redox species.

20. The method according to claim 18, wherein the second species of the second active redox couple is I₃⁻ and wherein the fluid moved to the second volume of the electrolyte storage tank is ZnI₆.

21. (canceled)

22. A method of operating a redox flow battery system comprising an electrolyte storage tank and an electrochemical cell having a first compartment separated from a second compartment by a porous membrane, the first and second compartments containing first and second electrodes respectively, the method comprising a discharge cycle with the steps of:
moving a fluid comprising a solvent from a second volume of a storage tank to a second compartment of an electrochemical cell comprising a second electrode;
reducing, at the second electrode, a second species of a second active redox couple to form a first species of the second active redox couple;
moving the fluid through the porous membrane to the first compartment of the electrochemical cell;
oxidising, at the first electrode, a second species of a first active redox couple to form a first species of the first active redox couple;
moving the fluid the first species of the first active redox couple from the first compartment of the electrochemical cell to a first volume of the storage tank,
wherein the first and second volumes of the storage tank are separated by a movable separator, and wherein the step of moving the fluid through the electrochemical cell involves moving the movable separator.

23. The method according to claim 22, wherein the first species of the second active redox couple is moved from the second compartment through the porous membrane to the first compartment, and from the first compartment to the first volume of the storage tank.

24. The method according to claim 22, wherein:
the first and second species of the second active redox couple are different I-based species selected from the group consisting of: I⁻ anions, I₂ and anions of Ix (where x is a number greater than or equal to 3).
the first and second species of the first active redox couple are metal species having different oxidation states.

25.-32. (canceled)
